(19) United States
(12) Patent Application Publication
(10) Pub. No.: US 2013/0064738 A1
(43) Pub. Date: Mar. 14, 2013

(54) METHOD AND DEVICE FOR THE METERED ADDITION OF FLUIDS INTO REACTION VESSELS

(71) Applicants: Stefan Berger, Burgdorf (CH); Andreas Mãchler, Moosseedorf (CH); Christine Schnetz, Solothurn (CH); Manfred Schär, Burgdorf (CH); Fritz Bircher, Madiswil (CH); Philipp Haslebacher, Wasen (CH)

(72) Inventors: Stefan Berger, Burgdorf (CH); Andreas Mãchler, Moosseedorf (CH); Christine Schnetz, Solothurn (CH); Manfred Schär, Burgdorf (CH); Fritz Bircher, Madiswil (CH); Philipp Haslebacher, Wasen (CH)

(21) Appl. No.: 13/580,185

(22) PCT Filed: Feb. 21, 2011
(86) PCT No.: PCT/EP2011/052545

§ 371 Date: Nov. 27, 2012

(30) Foreign Application Priority Data
Feb. 22, 2010 (CH) 00217/10
Jul. 30, 2010 (CH) 01259/10

(51) Int. Cl. B01L 3/02; G01N 1/10

(52) U.S. Cl. 422/521; 436/180

(57) ABSTRACT

Proposed is a metering device (87, 54) for introducing a fluid (31) into a reaction vessel such as, for example, a bioreactor (2). The metering device according to the disclosure comprises a closure element (89) for closing the reaction vessel, at least one drop generator (33) arranged in the closure element, and a feed line (91) serving for feeding the fluid to the at least one drop generator. The drop generator comprises a nozzle (36) for dispensing the fluid into the reaction vessel, and a valve (35). In the closed state, the valve disconnects the nozzle from the feed line. The drop generator is suitable for generating individual drops of the fluid.

### TECHNICAL FIELD

The invention relates to devices and methods for precise and sterile metered addition of liquids and gases into reaction vessels.

### PRIOR ART

From prior art, many approaches for metering liquids and gases are known which, however, do not satisfy the special needs in biotechnology. The prior art is represented hereinafter based on selected examples.

Generally known for precisely and automatically metering small amounts of fluids are peristaltic pumps, pneumatically driven metering systems, motor-driven syringes and burettes as well as robotic pipetting systems.

DE 10 2006 030 068 A1 discloses a device for feeding and discharging fluids in shaken microreactor arrays. Used are standard microtiter plates, wherein one or a plurality of fluid channels runs to the reactors, which channels can be individually controlled and regulated for process control. The amounts of fluid fed or discharged are fed in or fed out of the volume of the reaction fluid during a continuous shaking process. For controlling the fluids in the channels and for feeding the fluids drop by drop into closed microreactor arrays, besides shape memory alloys, piezo crystals are also proposed. The disadvantage of these proposed solutions is that these metering systems cannot be sterilized in an autoclave. Due to the lack of temperature resistance and the sensitivity to a moist environment, piezo crystals are not autoclavable. The same applies to deformable polymers which easily become brittle.

DE 603 02 477 T2 describes a system for precisely dispensing liquids. The liquid is contained in a container which is pumped up with a PID-controlled air pump to a constant overpressure of 34.5 kPa. Quick-acting magnetic valves are opened with a needle pulse holding voltage for the duration of the metering time. The user specifies the metering volume flow from which the control system determines the required valve opening time by means of a stored calibration table. The disadvantage of this solution is that this metering concept is configured for a robotic pipetting system. Pipetting robots are expensive systems which take up a lot of space for their operation and require a complex infrastructure. Sterility can only be ensured in a voluminous laminar flow cabinet; operation on a shaking table is not possible for mechanical reasons.

### OBJECT OF THE INVENTION

It is an object of the invention to provide a metering unit which does not have the mentioned and other disadvantages. In particular, a metering unit shall have a space-saving design. In addition, the metering unit shall be sterilizable, e.g., in an autoclave, and shall have a high metering accuracy.

It is another object to provide a metering unit by means of which very small drop volumes can be individually metered over longer periods.

This object is achieved by a metering unit and a metering system as well as a metering method according to the independent claims. Further advantageous embodiments arise from the dependent claims.

### REPRESENTATION OF THE INVENTION

A metering device according to the invention for introducing a fluid into a reaction vessel comprises a closure element for closing the reaction vessel, at least one drop generator arranged in the closure element, and a feed line which serves for feeding the fluid to the at least one drop generator. The drop generator has a nozzle for dispensing the fluid into the reaction vessel, and a valve, wherein in the closed state, the valve disconnects the nozzle from the feed line, and wherein the drop generator is suitable for generating individual drops of the fluid.

In a preferred embodiment, the valve of the drop generator is electromagnetically actuatable. Suitable is a valve as described, for example, in WO 2008/083509. The disclosure of this document forms an integral part of this description.

When the valve opens, fluid flows into the nozzle and upon closing, said fluid exits the nozzle with high speed as an individual drop with a defined fluid volume. In this manner, very small drop volumes can be metered with high precision into the reaction vessel. Besides metering aqueous solutions, metering liquids such as acids, lyes, solvents and liquids with increased viscosity and also metering gases is possible with the metering device according to the invention. With the metering device according to the invention, fluids with a viscosity of up to 150 mPa·s can be metered.

In a preferred embodiment, a metering device according to the invention can meter fluid into a plurality of reaction vessels, for example, a nutrient solution into the individual reactors of a multiwell bioreactor plate. The reaction vessels are closed in a sterile manner by a closure element. In a preferred embodiment, one closure element is provided per reaction vessel, and at least one drop generator is provided.

A multi-metering device according to the invention comprises a plurality of metering devices according to the invention, wherein the metering devices are arranged on a grid plate. This grid plate corresponds to the arrangement of the bioreactors on the multiwell bioreactor plate.

Furthermore, a metering device according to the invention can comprise a venting device suitable for dissipating overpressure from the reaction vessel.

Likewise, a device for measuring the pressure in the reaction vessel can be provided, which device is preferably arranged on the closure element, and/or a device for taking samples from the reaction vessel can be provided.

Compared to solutions from the prior art, it is possible with the metering device according to the invention to meter very small amounts with a very low frequency, for example, one drop at 100 nl per day, over very long periods, for example, two weeks, without experiencing losses with regard to the accuracy of metering. Moreover, the metering device according to the invention prevents the drop generator from drying out or from clogging. Also possible are extended metering stops, for example, over several weeks.

Moreover, an advantage of the metering device according to the invention is that with each metering, cavitation bubbles are generated which function as a sterile barrier.

The metering device according to the invention is configured such that it can be used multiple times and can be sterilized multiple times. The materials used for the metering device according to the invention, for example, cut glass for the valves, metals, ceramic materials and heat-resistant plastics, can be heated multiple times to 150° C.

In another advantageous preferred embodiment of the invention, the metering unit is provided for single use.

A metering system for metering at least one fluid into one or a plurality of reaction vessels comprises at least one metering device according to the invention and a device for pressurizing one or a plurality of reservoirs for the at least one fluid, at least one feed line for transporting the at least one fluid from the at least one reservoir to the at least one metering device, a device for measuring the pressure in the reaction vessel, and a control device. The control device is suitable for controlling the at least one metering device and the device for pressurizing.

An advantage of the metering system according to the invention is that per reaction vessel at least one fluid can be fed. Depending on the requirement, any number of fluids can be fed in this manner to any number of reaction vessels. Through the process control unit, feeding the fluids can be controlled selectively and individually. Furthermore, the metering system according to the invention can be calibrated for each individual fluid.

A method according to the invention for metering a fluid with a specific viscosity and temperature into a reaction vessel comprises the following steps: Measuring a pressure p1 in the reaction vessel, measuring a pressure p2 in the feed line, opening a valve between the feed line and a nozzle during a certain period. When the nozzle opens, the fluid exits as an individual drop. The time period between opening and closing the valve is selected such that depending on the viscosity and the temperature of the fluid and also the positive pressure difference (p2−p1) between the pressure in the feed line p2 and the pressure in the reaction vessel p1, a determined drop volume is obtained. In this manner, a determined number of individual drops is generated during a certain period and thus, a certain added metered total volume is obtained.

In an advantageous variant of the method, a determined number of individual drops is generated in order to achieve a determined total volume of the added fluid, or a determined volume flow.

For example, drops can be added with a frequency of 1 s⁻¹ drops at 100 nl, which corresponds to a volume flow of 6 μl/min or 360 μl/h. If metering takes place every 10 s, accordingly, the volume flow is reduced to 36 μl/h.

With the metering method according to the invention, the achieved metering accuracy is significantly improved in comparison to conventional metering methods by means of a peristaltic pump. The method according to the invention is provided for metering into minute reactors (e.g., volumetric capacity of 100 μl) and for reactors with a volumetric capacity of, for example, 1000 l.

In addition, the method according to the invention is independent of changes in atmospheric pressure and of short-term pressure fluctuations in the reactor vessels.

Advantageously, a metering method according to the invention is carried out with a metering device according to the invention and/or a metering system according to the invention.

In one embodiment of the method according to the invention, for example, a cultivation program sets a determined first metering rate (set value) for metering the fluid. Said determined first metering rate can be stored in the cultivation program, for example, as linear or exponential feed strategy. Based on the determined first metering rate set in the cultivation program for the fluid, and the first pressure p1 in a headspace of a reaction vessel measured with a pressure sensor, and a specified required differential pressure of 0.05±0.001 MPa over the metering device, the control device calculates the differential pressure control value for an electropneumatic pressure regulator. Then, based on the resulting pressure difference (p2−p1) between the fluid pressure p2 upstream of the metering device, which can be derived from the measured value of a pressure sensor, and the measured inner pressure p1 downstream of the metering device in the reaction vessel, then, the control value for the metering device is calculated. In a first stage, the differential pressure control value (p2−p1) is converted in an output stage into an electrical set value signal and transmitted to an electropneumatic pressure regulator so as to keep the pressure difference within a determined narrow band. In a second stage, a special electrical pulse-frequency signal is then converted in a valve driver and is sent to the metering device where a valve is activated. The pulse width determines the opening period of the valve and thus determines, in dependence on the pressure difference (p2−p1) and also the viscosity, density and temperature of the fluid, the volume of an individual drop. The frequency of the control signal controls the number of drops per time unit, and therefore the determined first metering rate.

For increasing the accuracy of the method according to the invention, detecting a second measured metering rate (actual value) is also carried out by metering rate determination means, preferably weighing means or flow sensors. Said weighing means 135 involves a precision scale which is positioned, for example, underneath one or a plurality of reservoirs; preferably, one weighing means is provided per reservoir. In further embodiments, the weighing means are hanging scales or scale with an underfloor weighing unit. In these embodiments, the reservoir is located below the weighing means. For example, it is hooked beneath the weighing means.

By means of the precision scale, the weight change of the fluid in the reservoir is detected within a certain measuring interval and therefrom, the second metering rate is determined. Then, the comparison of the first metering rate with the second metering rate takes place. If the metering rate calculated by the control device does not match the metering rate measured by the metering rate determination means, an adjustment of the control values, for example, the frequency and the opening time of the metering device, is carried out so that the second measured metering rate (actual value) corresponds to the first determined metering rate (set value).

The metering system for metering at least one fluid at a determined first metering rate from a reservoir into one or a plurality of reaction vessels comprises at least one metering device, a means for determining a first pressure downstream of the metering device and a means for determining a second pressure upstream of the metering device, and a device for pressurization, wherein said device is suitable for pressurizing the fluid in the reservoir at the second pressure. Furthermore, the metering system according to the invention comprises a control device, wherein the control device is suitable for setting at least one control value for the metering device on the basis of a differential pressure between the second pressure and the first pressure and the determined first metering rate. Furthermore, the metering system according to the invention comprises metering rate determination means, wherein said metering rate determination means are suitable for measuring a second metering rate, and the control device is suitable for readjusting the at least one control value on the basis of a difference between the first metering rate determined by the control device and the second metering rate measured with the metering rate determination means.

In one embodiment of the metering system according to the invention, the metering rate determination means comprise weighing means, preferably a precision scale. The at least one weighing means is suitable for measuring the second measured metering rate by determining a mass difference of the fluid in the reservoir within a certain measuring interval.

In a further embodiment of the metering system according to the invention, the metering rate determination means is a flow sensor, wherein the flow sensor is arranged in a transfer line between the at least one reservoir and the metering device and is suitable for detecting the second measured metering rate. The flow sensor is, for example, a single use flow sensor.

In a further embodiment of the metering device according to the invention, the means for determining the second pressure comprises a pressure sensor, for example a single use flow sensor.

In a further embodiment of the metering system according to the invention, the pressure sensor is integrated in the metering device.

In a further embodiment of the metering system according to the invention, the pressure sensor comprises a bypass, wherein the pressure sensor has a first flow cross-section and the bypass has a second flow cross-section, and the second flow cross-section of the bypass is larger than the first flow cross-section of the pressure sensor.

In the method according to the invention for metering a fluid at a determined first metering rate from a reservoir into a reaction vessel using a metering device which is suitable for generating individual drops of the fluid, a second pressure upstream of the metering device is detected and a first pressure downstream of the metering device is detected. From the difference between the second pressure and the first pressure, a differential pressure is formed. From the differential pressure and the first metering rate determined by the control device, at least one control value for the metering device is determined, wherein the at least one control value comprises the opening period and/or the frequency of the metering device.

By means of metering rate determination means, a second metering rate is measured wherein the at least one control value is readjusted based on a difference between the first determined metering rate and the second measured metering rate.

In a further embodiment variant according to the invention, the method comprises a control device which controls the opening period and/or the frequency of the metering device in such a manner that the second measured metering rate (actual value) corresponds to the first metering rate (set value) determined by the control device.

In a further embodiment variant, at least one weighing means is used as a metering rate determination means, wherein the at least one weighing means is arranged below or above one or a plurality of reservoirs. The metering rate determination means determines a weight value of the fluid in the reservoir, wherein the change of the weight value within a certain measuring interval corresponds to the second measured metering rate.

In a further embodiment variant, at least one flow sensor is used as a metering rate determination means, wherein the flow sensor determines the second measured metering rate.

In a preferred embodiment variant of the method according to the invention, a metering system according to the invention is used.

### BRIEF DESCRIPTION OF THE DRAWINGS

The invention is illustrated hereinafter by means of figures which only show exemplary embodiments.

FIG. 1 shows schematically a cross-section through a metering device according to the invention, mounted on a reaction vessel.

FIG. 2 shows a schematic sectional view through the drop generator of a metering device according to the invention, wherein (a), the valve is open and fluid flows through the line, and (b), wherein the valve is closed.

FIG. 3 shows a cross-section through a possible embodiment of a metering device according to the invention for use with autoclavable bioreactors.

FIG. 4 shows a cross-section through another possible embodiment of a metering device according to the invention for use with a small bioreactor.

FIG. 5 shows a top view of a 24-well multiwell plate.

FIG. 6 shows a cross-section through an individual bioreactor.

FIG. 7 shows a possible embodiment of a metering system according to the invention.

FIG. 8 shows another embodiment of a metering system according to the invention with a common reservoir and a plurality of metering devices according to the invention.

FIG. 9 shows an embodiment of a metering system according to the invention with a metering device having a plurality of reservoirs and a plurality of drop generators.

FIG. 10 shows a metering device according to the invention with an additional pressure chamber for use with flexible bags as a reservoir.

FIG. 11 shows a cross-section through a possible embodiment of a pressure tank of a metering system according to the invention.

FIG. 12 shows a metering system according to the invention with an additional device for taking samples.

FIG. 13 shows a perspective view of a bioreactor multiwell plate onto which a multi-metering device according to the invention is mounted.

FIG. 14 shows a cross-section through the multi-metering device and the reactor plate of FIG. 13.

FIG. 15 shows a detail of FIG. 14.

FIG. 16 shows a perspective view of a bioreactor multiwell plate onto which another embodiment of a multi-metering device according to the invention is mounted.

FIG. 17 shows a cross-section through a multi-metering device and the reactor plate of FIG. 16.

FIG. 18 shows a detail of FIG. 17

FIG. 19 shows a side view of the mounting device for the metering device according to the invention (not shown).

FIG. 20 shows a perspective view of the mounting device from above with the metering device being attached onto a plurality of reactor vessels.

FIG. 21 shows another possible embodiment of the metering system according to the invention with a pressure sensor and a bypass.

FIG. 22 shows a sectional view of the pressure sensor and the bypass connected to the drop generator.

FIG. 23 shows a sectional view of an adaptor for metering minimal amounts.

FIG. 24 shows a possible embodiment of the metering system according to the invention with flow sensor, pressure sensor and bypass.

FIG. 25 shows a possible embodiment of the metering system according to the invention with weighing means, pressure sensor and bypass.

FIG. 26 shows a possible embodiment of the metering system according to the invention with weighing means, flow sensor and bypass.

### IMPLEMENTATION OF THE INVENTION

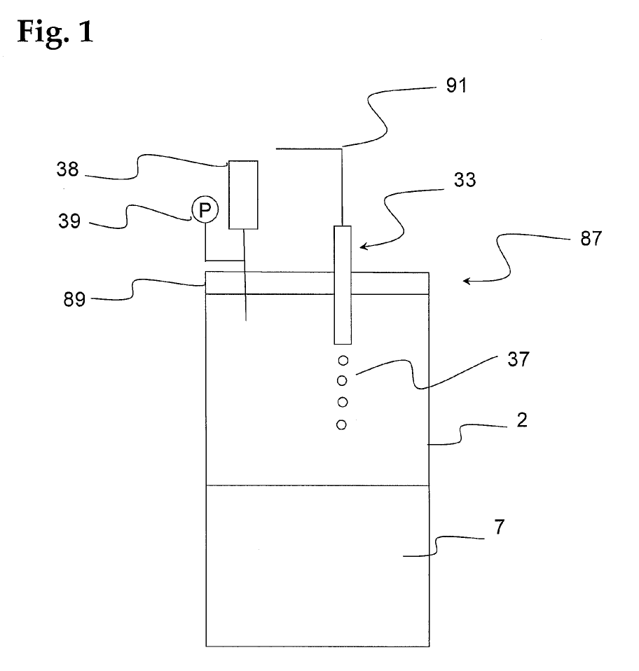

FIG. 1 shows schematically the structure of a possible embodiment of a metering device 87 according to the invention. A reactor vessel 2 is tightly closed on top by means of a closure element 89 of the metering device 87. In a preferred embodiment, the drop generator 33 is arranged in the closure element 89. The drop generator 33 is supplied with fluid 31 through the feed line 91. By opening and closing a valve (not illustrated), the fluid is introduced as individual drops 37 into the reaction vessel 2. The pressure in the reaction vessel 2 is detected by a device for measuring the pressure 39. The overpressure generated in the reaction vessel 2 is dissipated through the venting device 38.

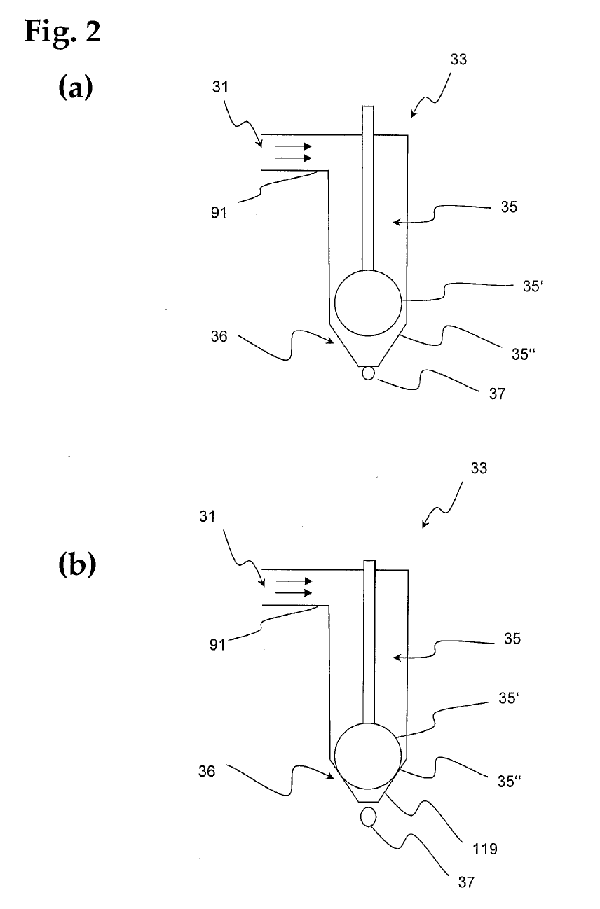

The drop generator 33 of a metering device 87 according to the invention comprises a valve 35, a nozzle 36, and a feed line 91 through which the fluid 31 is supplied. FIG. 2(a) shows schematically the drop generator 33 of a metering device according to the invention with an open valve 35. In the advantageous example shown, the valve 35 comprises a valve ball 35′ and a valve seat 35″. In the opened state of the valve 35, the fluid flows around the valve ball and enters into the nozzle 36. In said nozzle, the fluid is accelerated.

If now the valve 35 closes, as illustrated in FIG. 2(b), the valve ball pushes against the inner wall 119 or, respectively, the valve seat 35″. The nozzle 36 is disconnected from the feed line 91 and no further fluid 31 can flow in. The fluid volume already contained in the nozzle 36 leaves the nozzle and forms a drop 37 which flies away from the drop generator 33 with high speed, for example between 2 and 10 m/s, toward the interior of the reaction vessel 2. Thus, an individual dose of the fluid has now been added into the reaction vessel 2. This process can be repeated as required.

In a preferred embodiment of the invention, the valve 35 is actuated electromagnetically so that the valve can be flexibly activated with a pulsed signal so as to achieve a drop sequence with the desired frequency and the desired drop volumes.

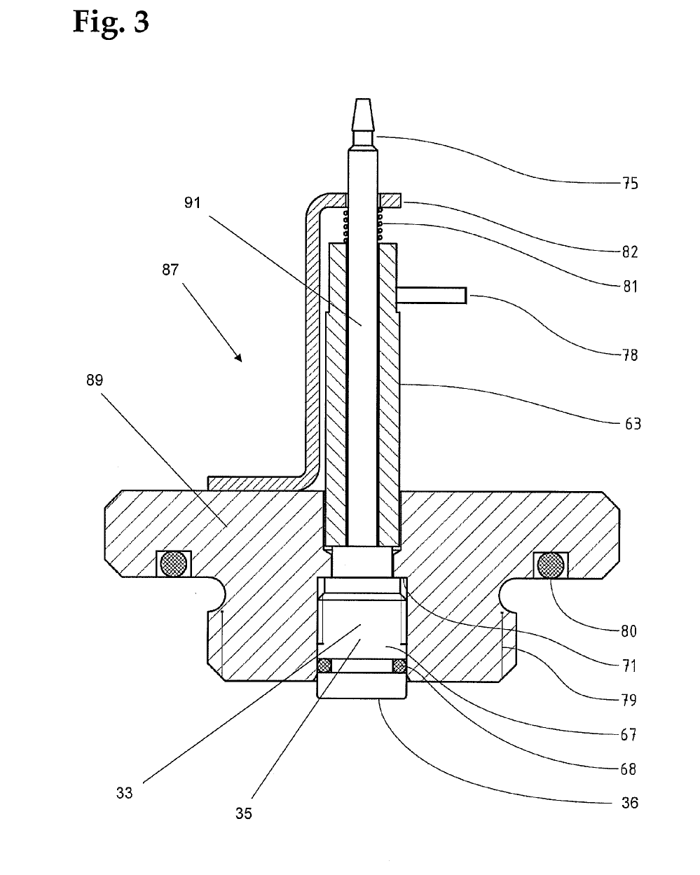

FIG. 3 shows a cross-section through a possible embodiment of a metering device 87 according to the invention which is specifically suitable for use with autoclavable bioreactors. The metering device is screwed with an external thread 79 of the closure element 89 into a free port bore of the port plate of a bioreactor (not illustrated). An O-ring 80 ensures a pressure-resistant, sterile sealing between port plate and closure element. In the center of the closure element 89, the drop generator with valve 35 and nozzle 36 is arranged. A threaded ring 67 is adhesively bonded in a sterile manner on the base body of the valve 35. The adhesive used is FDA-compliant and autoclavable. The valve 35 is then screwed into the closure element 89 up to the stop. An O-ring seals the connection between the valve and the insert in a sterile manner. A downholder 82 with spring element 81 secures the coil 63 from above in a play-free manner. The coil is rotatably fixed so that the connecting wires of the coil can be aligned as required. A tube connection 75 allows coupling the feed line 91 to a transfer line 32.

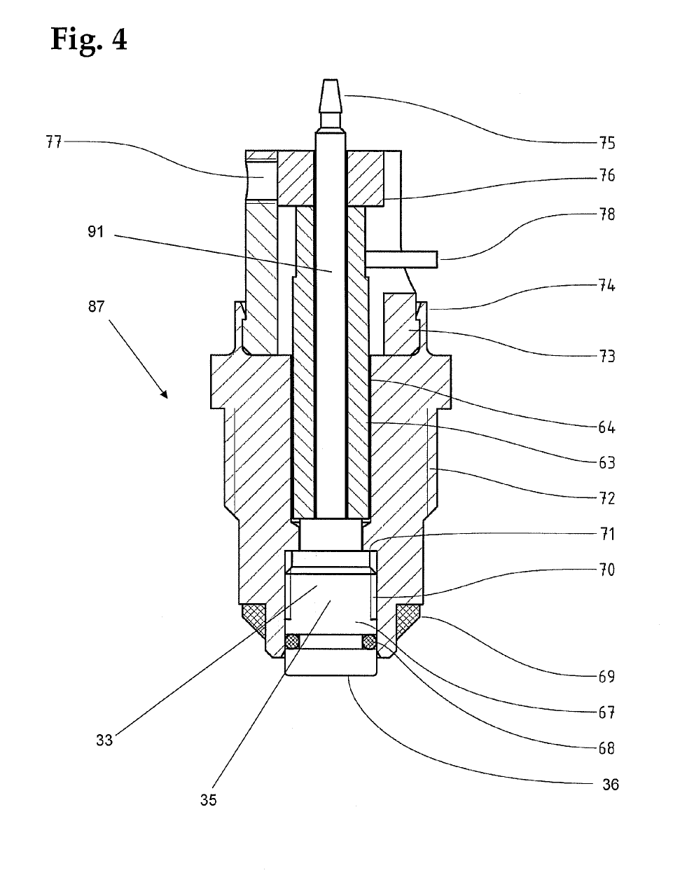

An alternative embodiment of a metering device 87 according to the invention is illustrated in FIG. 4. This variant is particularly suitable for individual small bioreactors. The metering device 87 is screwed with the thread 72 into a free port bore of the port plate of the bioreactor (not illustrated). A sealing ring 69 seals the connection between the metering device 87 and the port plate in a sterile manner. The drop generator 33 with valve 35 and nozzle 36 is arranged in the center of the closure element. A threaded ring 67 is adhesively bonded in a sterile manner on the base body of the valve 35. The adhesive used is FDA-compliant and autoclavable. The valve 35 is then screwed into the closure element 89 up to the stop 71, and an O-ring 68 seals the connection between the valve and the insert in a sterile manner. On this unit, the coil body 63 is slid onto the feed line 91 of the drop generator and is positively held by a snap-in member 73, 76. The snap-in connector is advantageously configured in such a manner that coil 63 and coil holder 73 are rotatable so that the connecting wires 78 of the coil can be aligned as required. A connector 75 of the feed line 91 serves for connecting to a transfer line 32.

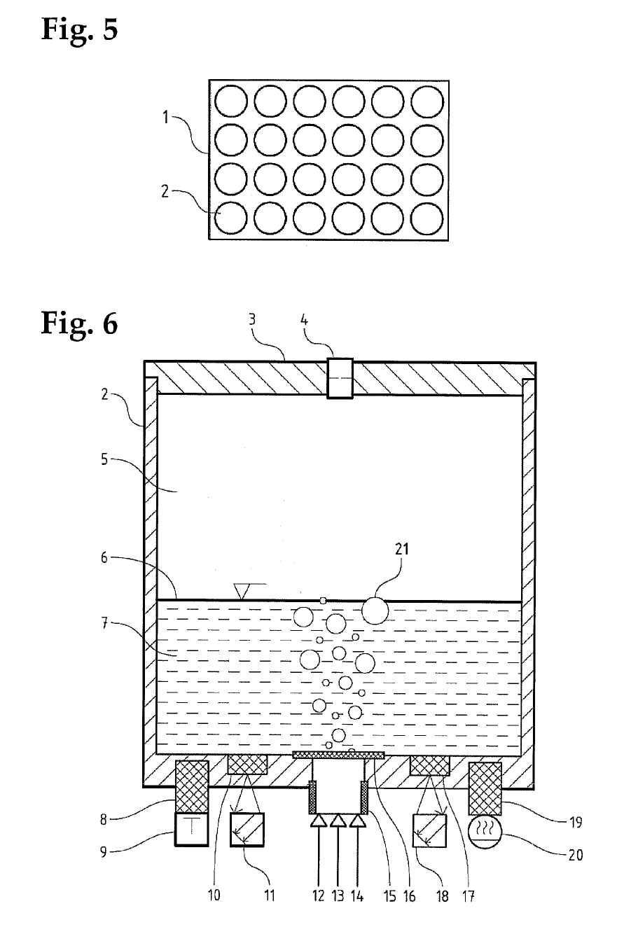

A metering device according to the invention can be used for different reaction vessels, for example, for multiwell plates as used for chemical, biochemical and microbiological testing. FIG. 5 shows exemplary a top view of a commercially available, SBS-standard-compliant multiwell bioreactor plate 1 with the format 128×86 mm on which altogether 24 reaction vessels 2 are built up which, in the present case, are called bioreactors, and which have a reactor volume of 5 to 50 ml and an adequately recommended culture volume. With such a multiwell bioreactor plate 1, up to 24 microbiological processes can be run in parallel.

FIG. 6 shows a cross-section through an individual reaction vessel using the example of an individual bioreactor 2. The bioreactor is sealed in a sterile manner from the outside with a sterile seal 3. The bioreactor 2 is filled up to the fluid level 6 with culture medium 7. The headspace 5 of the interior above the culture medium 7 is vented through a sterile filter 4 against the atmospheric pressure.

In the example shown, the reactor temperature is measured with a temperature sensor 9 which is coupled to the reactor bottom by means of a heat conductor 8. The reactor temperature can be increased with a heater 20 which is coupled to the reactor bottom by means of a heat conductor 19.

The reaction vessel 2 can be supplied with CO₂ gas 12 for reducing the pH value, with O₂ gas or air 13 for increasing the DO value, and with NH₃ gas for increasing the pH value. The gases are introduced into the culture medium 7 via a sealing element and a sterile semi-permeable membrane 16 and rise as gas bubbles 21 up to the headspace 5 of the bioreactor. For measuring the pH value, a pH sensor in the form of a ph-sensitive material 10 is arranged in the reaction vessel as well as an optical sensor 11 which is directed toward said pH sensor and delivers the measured value required for determining the pH value in the culture medium 7. For measuring the oxygen content in the reaction vessel 2, an oxygen-sensitive material 17 is embedded, toward which, again, an optical sensor 18 is directed which detects the required measured value for determining the DO (dissolved oxygen) value in the culture medium 7.

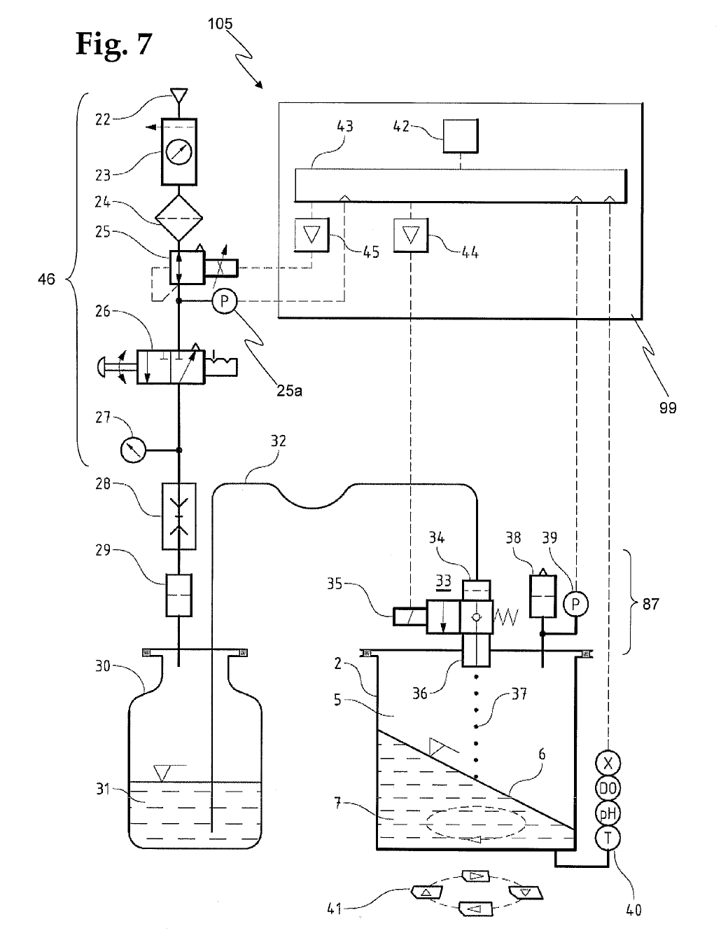

A metering device 87 according to the invention as part of a metering system 105 according to the invention is schematically illustrated in FIG. 7. A metering device 87 according to the invention is arranged on a reaction vessel 2. A closure element 89 of the metering device 87 tightly seals the reaction vessel with respect to the surroundings. The bioreactor 2 is shaken with an orbital shaker 41 (illustrated only symbolically) with an orbital diameter of, for example, 5 mm and a frequency of 0 to 1000 min⁻¹ so as to ensure a thorough mixing of the culture medium 7 and, at the same time, to achieve that the introduced fluid 31 is rapidly mixed in. Such a fluid 31 to be admixed can be, for example, a feed fluid for the microorganisms in the culture medium 7 of the bioreactor. Due to the biotechnological processes in the bioreactor 2, overpressure can develop therein which is discharged to the atmosphere through a sterile filter vent 38. In the example shown, the sterile filter vent 38 is attached to the closure element 89.

The metering device 87 has a drop generator 33, comprising a feed line 91 for the fluid 31, a valve 35, and a downstream nozzle 36. As shown in the example, a particle filter 34 with a mesh size of, for example, 17 μm can be arranged in the feed line. By means of overpressure in the reservoir 30, the fluid is conveyed through a suitable transfer line 32 from a reservoir 30 to the feed line of the drop generator 33. The fluid 31 in the feed line is under overpressure with respect to the reaction vessel. The nozzle 36 can have a diameter of 0.15 mm, for example.

The drop generator 33 meters the fluid 31 so as to form individual drops 37 with a defined volume of 100 nl to 100 μl. By rapidly opening and closing the electromagnetically actuatable valve 35, a defined amount of the fluid 31 gets into the nozzle and leaves the latter as an individual drop 37. Due to the high acceleration of the fluid in the nozzle, the drop 37 has a speed in free flight of 2 to 10 m/s. This speed is significantly higher than the orbital speed so that during the flight phase, the shaken liquid culture medium 7 can be considered as being static. The drop 37 crosses the headspace 5 and impinges on the surface 6 of the culture medium 7. There, it is subsequently mixed together with the culture medium 7. By repeatedly opening the valve 35, the drop generator 33 can generate a precisely specified number of drops 37 and thus can achieve a greater metering volume and/or can control the metering speed.

When the pressure p1 in the reactor 2 exceeds a certain value with respect to the external pressure, this overpressure is dissipated through the venting device 38. The average pressure in the reaction vessel 2 is therefore substantially constant. In order to improve the accuracy of the individual drop volumes and therefore to improve the metering accuracy, the pressure p1 in the headspace 5 of the reaction vessel 2 is measured with a pressure sensor 39 and transmitted to a process controller 43 of a control device 99 of a metering system 105 according to the invention. Moreover, the metering system 105 has a device 46 for pressurizing the reservoir 30. This device 46, which is controlled by the process control unit 43, enables controlling the pressure p2 inside the reservoir 30 within a defined range.

In the illustrated variant, the device 46 has a compressed air source 22 with dry, oil-free compressed air and a system pressure of 0.2 . . . 0.7 MPa. The compressed air source 22 is connected to a maintenance unit 23 which filters the compressed air and reduces the pressure to 0.2 MPa. A downstream micro-filter 24 with a mesh size of, for example, 0.3 μm removes particles from the compresses air. An electropneumatic pressure regulator 25, which can be activated by the process control unit 43, reduces the air pressure and regulates the pressure to the desired value in the range from 0.005 to 0.1 MPa with an accuracy of ±0.001 MPa. The resulting pressure is measured with a pressure sensor 25a and transmitted to the process control unit 43. With a 4-port/2-way shut-off valve 26, the compressed air is connected as required to the downstream system, or the latter is depressurized. A manometer 27 indicates the pressure in the system to the user for visual control. A quick coupling 28 forms the interface from the pressure supply unit 46 to the downstream system. The compressed air is introduced into the reservoir 30 through a sterile filter 29. The resulting pressure p2 in the reservoir drives the feed fluid 31 through a suitable transfer line 32, for example, a sterile tube 32, to the feed line of the drop generator 33 of the metering device 87 according to the invention.

A cultivation program 42 specifies, among other things, the set values for metering the fluid 31. The set values can be stored in the cultivation program 42, for example, as linear or exponential feed strategies. Based on the set value of the volume flow specified for the fluid 31 in the cultivation program 42, the pressure p1 in the headspace 5 measured with the pressure sensor 39, and a specified required differential pressure of 0.05±0.001 MPa over the drop generator 33, the process controller 43 calculates the differential pressure control value for the electropneumatic pressure regulator 25. With the resulting pressure difference (p2−p1) between the fluid pressure p2 upstream of the valve 35, which can be derived from the measured value of the pressure sensor 25a, and the measured internal pressure p1 in the reactor 2, then, the control value for the drop generator 33 is calculated. In a first stage, the differential pressure control value (p2−p1) is converted in the output stage 45 into an electrical set value signal and transmitted to the electropneumatic pressure regulator 25 in order to keep the pressure difference within a defined narrow range. In a second stage, a special electrical pulse-frequency signal is then converted in the valve driver 44 and sent to the drop generator 33 where it activates the valve 35. The pulse width determines the opening period of the valve 35 and therefore, in dependence on the pressure difference (p2−p1) and also the viscosity, density and temperature of the fluid, the volume of an individual drop 37. The frequency of the control signal regulates the number of drops per time unit and hence the metering speed.

By considering the rheological properties of the fluid, the metering accuracy can be made independent over a wide temperature range of 15 to 50° C.

### Example 1

The required differential pressure is 0.05 MPa. The overpressure in the headspace 5 measured with the pressure sensor 39 is 0.02 MPa. The differential pressure control value for the electropneumatic pressure regulator 25 is 0.07 MPa and is equal to the differential pressure of 0.05 MPa plus the overpressure (internal pressure p1 less atmospheric pressure) of 0.002 MPa in the headspace 5. Static pressure drops, for example through the sterile filter 29, are preferably also considered here.

### Example 2

The volume flow for the feed fluid 31 shall be 1 ml/h. At a pulse width with a duration of 10,000 μs, the metering unit 33 generates a drop 37 with a volume of 1000 nl. Accordingly, the valve driver 44 has to generate a pulse every 3.6 s.

Preferably, the process control unit 43 can utilize further relevant measured values X in the bioreactor such as, for example, temperature T, pH, DO, and can include them in a cultivation program 42 as well.

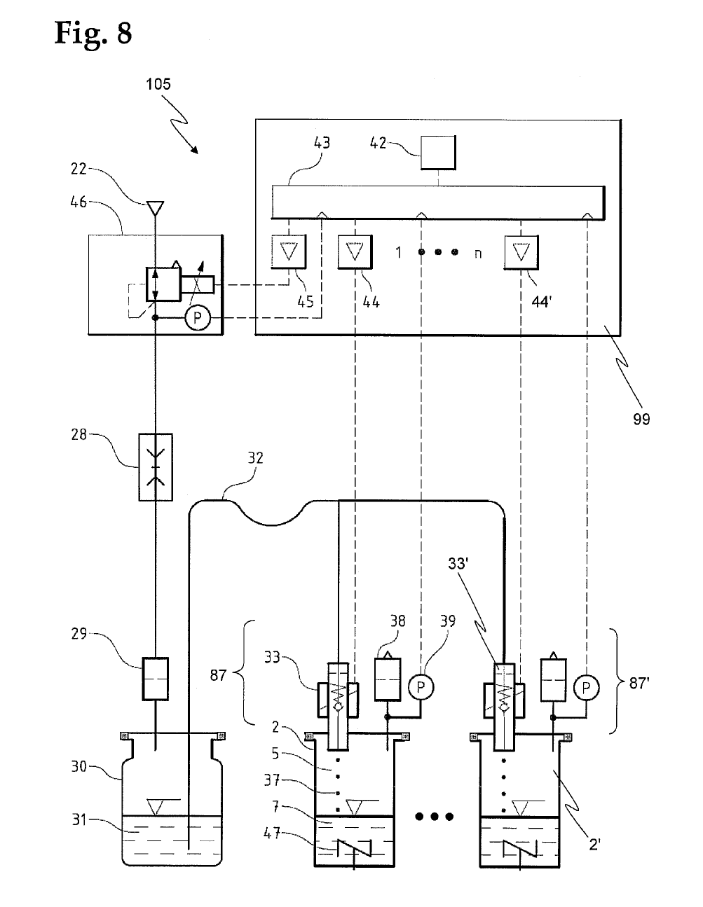

FIG. 8 shows an embodiment variant of a metering system 105 according to the invention in which fluid 31 flows from a common reservoir 30 via a common transfer line 32 into a plurality of metering devices 87, 87′ according to the invention which are in each case attached on a bioreactor 2, 2′. For a simplified illustration, the particle filter 34, the valve 35 and the nozzle 36 are illustrated combined as a drop generator 33. In the illustrated example, the bioreactors 2, 2′ have stirrers 47 attached at the bottom so as to achieve a thorough intermixing of culture medium 7 and added fluid 31.

Overpressure in the bioreactor 2, 2′ can be discharged to the atmosphere, again, through a sterile filter vent 38. The pressure p1, p1′ in each reaction vessel 2, 2′ is measured with an associated pressure sensor 39, and the detected value is transmitted to the process controller 43. A cultivation program 42 specifies the set values for metering the feed fluid 31 into the different bioreactors 2.

Since the pressure p2 in the common reservoir 30 is identical for all metering devices 87, 87′, different metering volumes for the different reactors 2, 2′ are regulated through the pulse width and/or the pulse frequency of the control signal of the respective valve.

The process controller 43 can process the cultivation program 42 simultaneously for all reactors. However, for rather slow biotechnological processes it is advantageous to process the reactors successively in a multiplex method during a selectable period in the range of, for example, 0.1 to 10 s. The process controller 43 re-regulates the differential pressure of 0.05±0.001 MPa in each period individually for the respective metering device 87, 87′ in consideration of the overpressure measured with the pressure sensor 39 in the respective headspace 5 of the 1 to n bioreactors 2. The differential pressure control value is converted in the output stage 45 into an electrical set value signal and transmitted to the electropneumatic pressure regulator 25. The process controller 43 then determines the applicable pulse width and frequency for the respective drop generator 33, 33′ of the bioreactor. With the resulting individual control signals, then, the drop generators 33, 33′ are controlled by means of the valve drivers 44, 44′ of the control device 99.

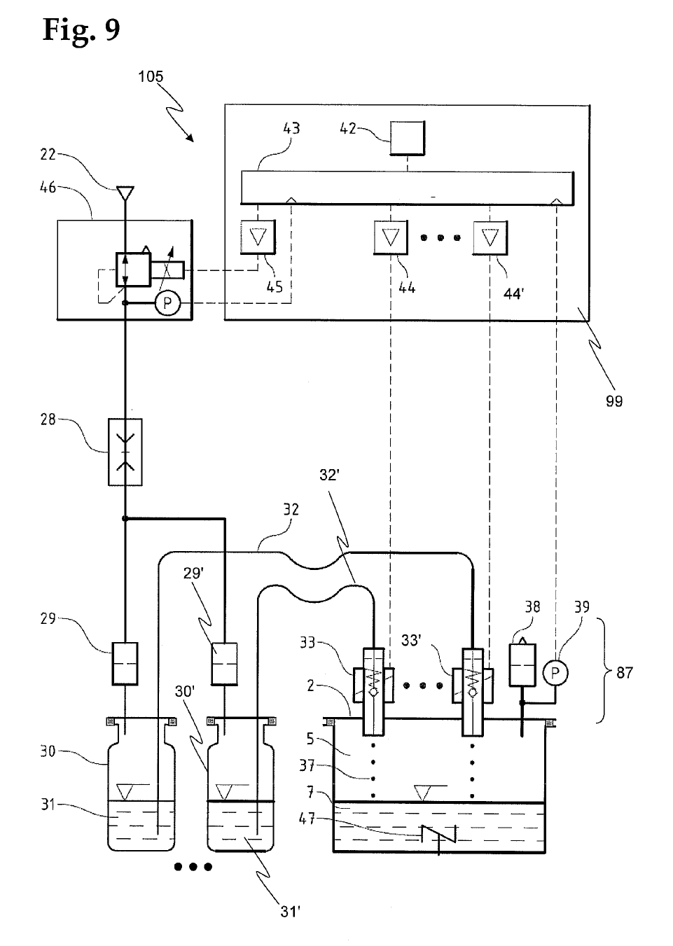

FIG. 9 shows another advantageous embodiment of a metering system 105 according to the invention, comprising a metering device 87 which is attached on an individual bioreactor 2 and which has a plurality of drop generators 33, 33′ which each receive a fluid 31, 31′ from a reservoir 30, 30′. The individual drop generators 33, 33′ can be activated separately by the process control unit 43.

The individual reservoirs 30, 30′ are connected to a common pressure regulating device 46 via a respective sterile filter 29, 29′. The applied pressure drives the respective fluid 31, 31′ through separate transfer lines 32, 32′ to the drop generators 33, 33′ of the metering device 87. The pressure in the bioreactor 2 is measured with a pressure sensor 39, and the detected value is transmitted to the process controller 43. A cultivation program 42 controls individually the metering of the individual fluids 31, 31′ into the reactor 2 by controlling the valves of the individual drop generators 33, 33′ with individual pulse-frequency control signals.

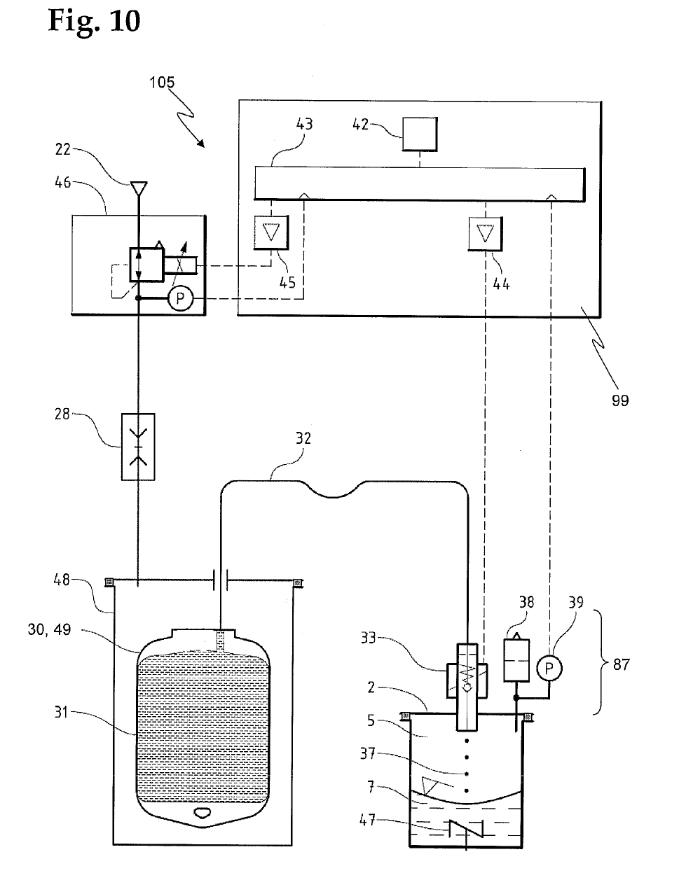

FIG. 10 discloses yet another variant of a metering device according to the invention in which a sterile bag 49 can be used as a reservoir for the fluid 31. The control unit 99 and the metering device 87 and the pressure supply unit 46 (illustrated simplified) correspond to the embodiment in FIG. 7. In addition, the metering system shown comprises a pressure chamber 48 which is connected to the pressure supply unit 46.

In the pressure chamber 48, a flexible bag 49 is arranged into which the feed fluid 31 has been introduced beforehand in a sterile manner. The pressure in the pressure chamber acts via the flexible bag wall directly on the fluid 31 and conveys the fluid 31 through the transfer line 32 to the drop generator 33 of the metering device 87.

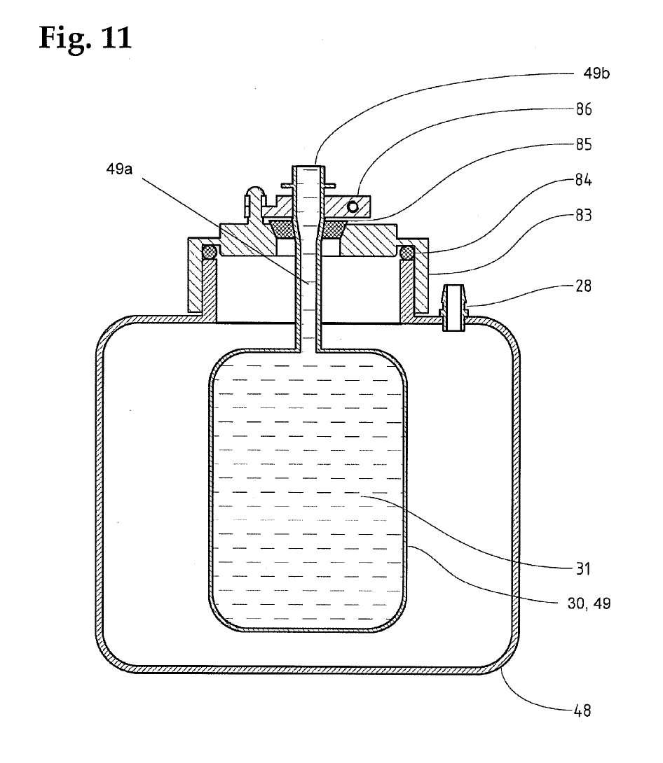

FIG. 11 shows in cross-section a possible embodiment of a pressure chamber 48 of a metering system 105 according to the invention in which a flexible bag 49 is arranged as a reservoir 30. The pressure chamber 48 is connected to the pressure supply unit 46 of the metering system 105 via a coupling 28. The pressure in the interior of the pressure chamber 48 acts on the bag 40 and conveys the fluid 31 through a transfer line to the metering device. The pressure vessel 48 is sealed by a seal 84 which is arranged between a screwcap 83 and the pressure chamber flange. The bag 49 is sealingly held with a split biconical seal in the pressure chamber. The mentioned biconical seal is pressed with a clamping ring 86 onto the sampling line 49a of the bag 49. The sampling line is coupled to a fluid transfer line 32 via a sterile coupling 49b.

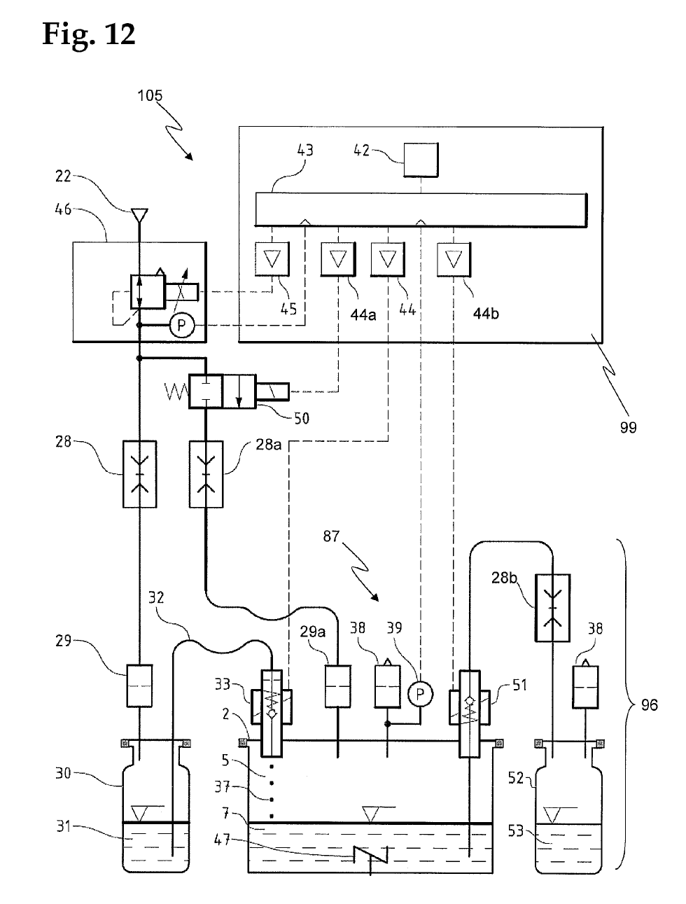

A particularly advantageous embodiment of a metering device 105 according to the invention is schematically illustrated in FIG. 12, comprising a device 96 for taking a sample from the culture medium 7 during cultivation.

The metering system 105 comprises a metering device 87, a control device 99 and a pressure supply unit 46. The metering device 87 has a drop generator 33 which receives fluid 31 from a reservoir 30 which is pressurized by the pressure supply unit 46.

In addition, a 2-port/2-way valve 50 is connected to the pressure supply unit 46, which valve can be controlled by the process controller 43 via a valve driver 44a. If a sample is to be taken, the valve 50 is opened so that the interior of the reactor 2 is pressurized via a quick coupling 28a and a sterile filter 29a. During sampling, the drop generator 33 remains out of operation. The process control unit 43 controls a sampling valve 51 via a valve driver 44b. The over pressure 2 in the reaction vessel 2 now conveys a sample 53 of the culture medium 7 through the sampling valve 51 into a sample container 52. The sample 53 taken is collected in the container 52 which is vented through a sterile filter vent 38.

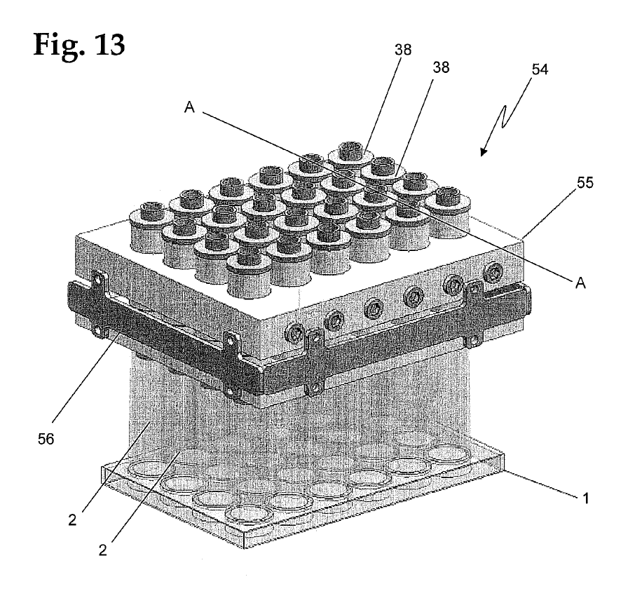

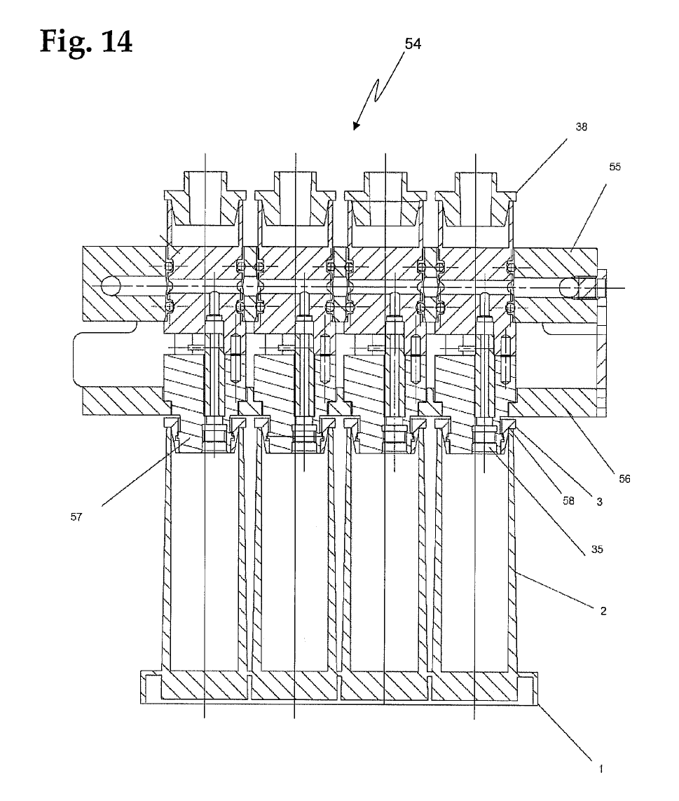

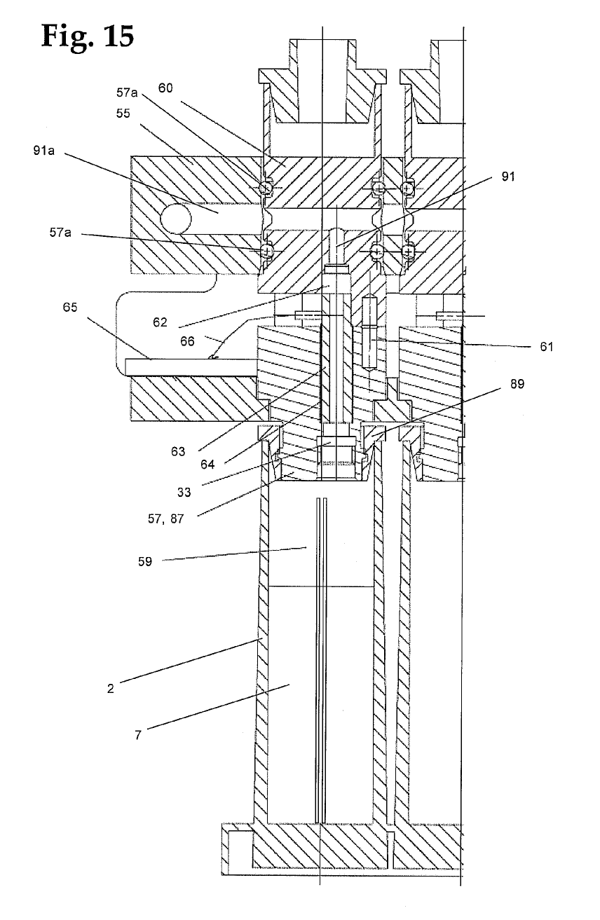

When using a metering device 87 according to the invention or a metering system 105 according to the invention for a plurality of structurally coupled reaction vessels such as, for example, a 24-well multiwell bioreactor plate 1 as shown in FIG. 5, preferably, instead of individual metering devices 87, multi-metering devices 54 according to the invention are used for the individual reactors. FIG. 13 shows a perspective view of a 24-well bioreactor plate 1 with 24 bioreactors 2 onto which a 24-channel multi-metering device 54 according to the invention is attached. FIG. 14 shows a cross-section through the multi-metering device 54 and the reactor plate 1 along the line A-A, and FIG. 15 shows a detail of FIG. 14.

The multi-metering unit 54 comprises a grid plate 56 with a perforation that corresponds to the arrangement of the bioreactors on the bioreactor plate 1. The grid plate aligns the inserts with the grid spacing. Individual metering devices 87 in the form of inserts 57 are arranged in the holes of the grid plate 56. Grid plate and inserts are provided with a radial clearance fit of 0.5 mm.

A drop generator 33 is arranged eccentrically in the metering device inserts 87, 57. In the example shown, the drop generator is screwed into the insert, wherein an O-ring seals the connection in a sterile manner. The eccentric arrangement ensures that also in the case of bioreactors 2 with a centrally arranged gassing pipe 59, all added metered drops get into the culture medium 7. A pin 61 in a bore 62 defines the rotatory position of the multi-distributor 55 and the insert 57 relative to each other. This ensures that the feed line 91 of the insert 57, 87 is correctly aligned with the feed line 91a in the multi-distributor 55.

The coil 63 of the electromechanically actuated valve 35 is firmly glued into the insert 57. The adhesive used is FDA (United States Food and Drug Administration)-compliant and autoclavable. The adhesive completely fills the annular gaps 64 between the coil and the insert and thus avoids a dead volume which is disadvantageous for autoclaving. Alternative mechanical mounting methods such as clamping, pressing and screwing etc. are also possible, but are complex.

For electrical contacting of the coils 63 of the multi-metering device, a printed circuit board 65 is provided. A pair of cables 66 is soldered onto the coil 63 and is connected to the printed circuit board 65. Due to the printed circuit board used here, a complicated cable harness, which is difficult to install, is eliminated.

Above the grid plate 56, a multi-distributor plate 55 is arranged which comprises a central fluid feed line 91a for all feed lines of the individual metering devices 87, 57 of the multi-metering device 54. O-rings 57a seal the connection between the feed lines 91, 91a in a sterile manner. The grid plate is coupled to the multi-distributor and presses the inserts against the multi-distributor.

Arranged on the metering device's 57 longitudinal end allocated to the bioreactor 2 is a closure element 89 in the form of a conical seal by means of which the bioreactor is hermetically sealed off from the surroundings. The seal is made of silicone and is able to offset deviations from the ideal grid spacing of 0.1 to 0.3 mm. This variant has the advantage that a metering device according to the invention can be assembled and disassembled with little effort on a bioreactor, but still seals the bioreactor in a sterile manner. It is also possible to use O-rings. However, conventional O-rings are too hard, get easily caught during assembly at the sharp inner edge of the bioreactor, and are cut there.

A longitudinal bore (not visible) connects the reactor-side end of the individual metering device 87 to a conventional sterile filter vent 38 attached on the opposite end. Said vent can be replaced after use.

In the example shown, the multi-metering device is held on the bioreactor plate only through the static friction forces of the sterile seal 89. It was found that when used in combination with an orbital shaker at 800 min⁻¹, the mass of the metering unit 54 should preferably be smaller than 1 kg so that, on the one hand, the orbital shaker is not mechanically overloaded and, on the other, the metering unit 54 is not slung away.

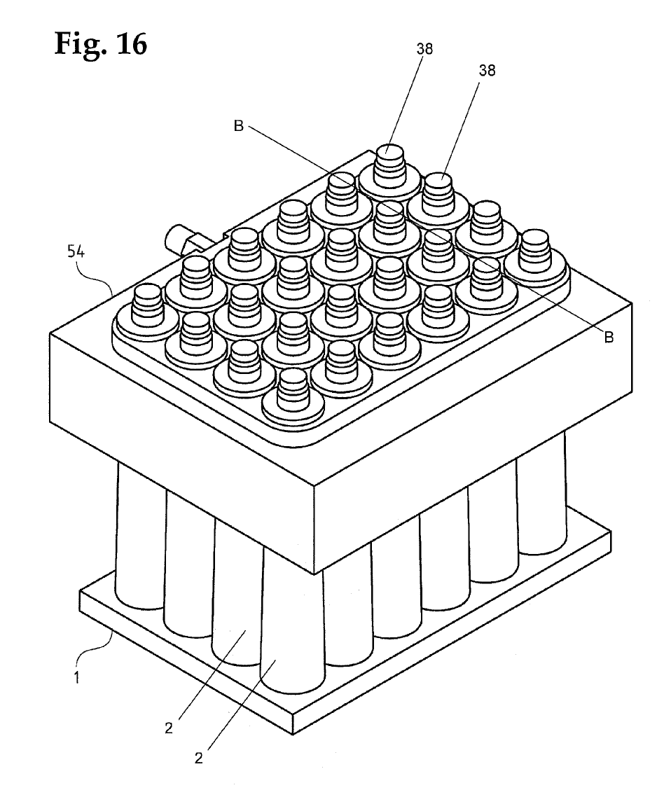

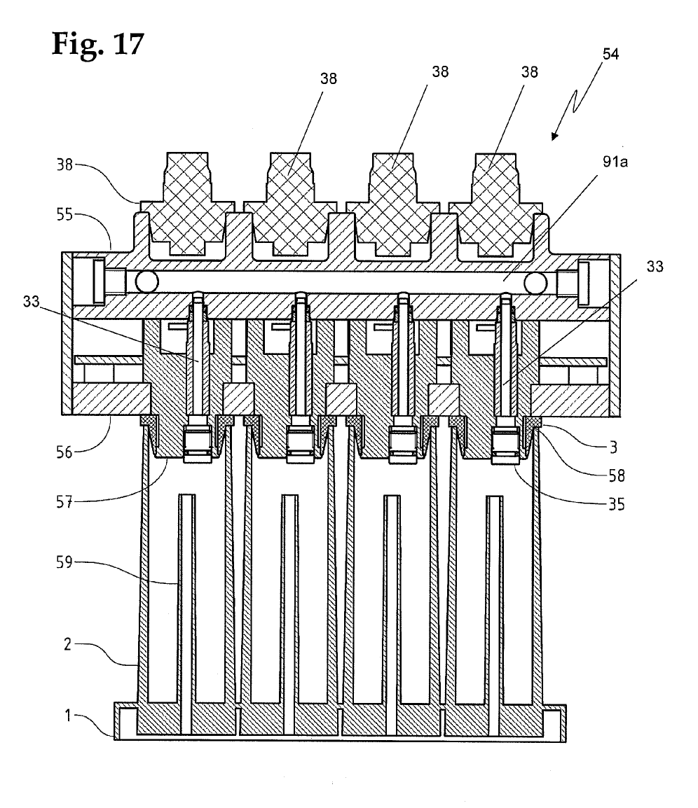

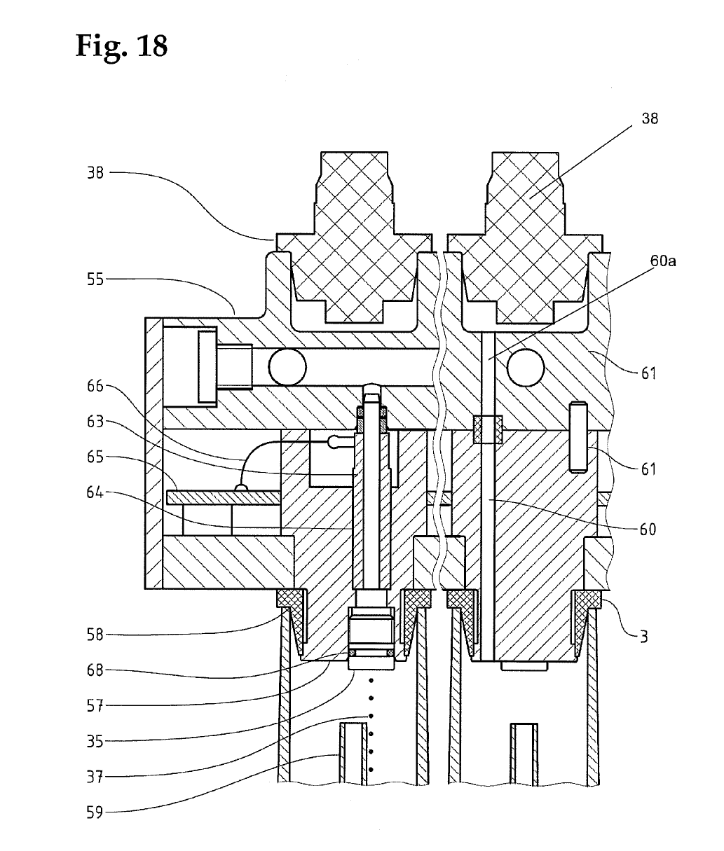

In an advantageous variant of a metering device according to the invention, vent lines are provided in the multi-distributor 55 which run from a sterile filter vent 38 attached in an opening of the multi-distributor 55 through a vent hole 60a to a vent hole in the insert 57. FIGS. 16 to 18 show such an embodiment of a metering device 54 according to the invention.

The insert 57 with the eccentrically arranged drop generator 33 is slid from above through the grid hole of the grid plate 56. The conical seal 58 is put from below over the insert 57. The inserts 57 are positively held between the grid plate 56 and the multi-distributor plate 55.

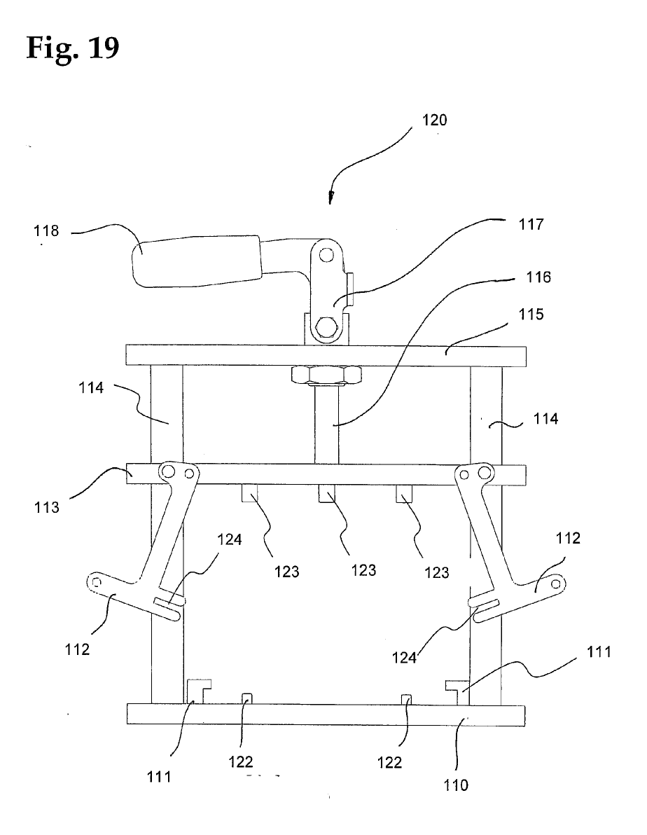

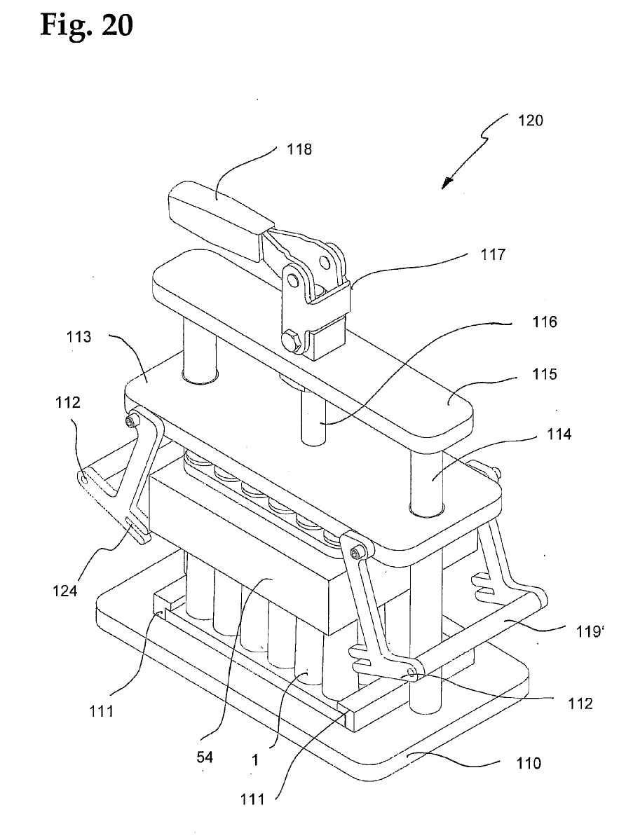

Assembly and disassembly of a multi-metering unit 54 according to the invention on a bioreactor plate takes place under sterile conditions in a laminar flow workbench by means of an assembly tool. FIGS. 19 and 30 show an assembly device 120 according to the invention for a multi-metering device 54.

In the illustrate preferred embodiment, the assembly device 120 comprises a base plate 110 with two downholders 111 in which the bioreactor plate 1 can be inserted. Two guide columns 11 carry a beam 115 and a lifting device 117 with a toggle lever 118. Said lifting device is connected via a bolt 116 to a pressing plate 113 which is penetrated by the support columns 114 so that the pressing plate 113 is displaceably mounted on the support columns 114. Two hooks 112 are attached laterally on the pressing plate 113 and are rotatably mounted.

During assembly, the multi-metering device 54 is placed onto the bioreactor plate 1, wherein the conical sterile seals 89 position the metering device. The bioreactor plate 1 is slid on the base plate 110 into the downholders 111. Due to the pivotable mounting of the hooks 112 on the guide plate 113, the metering device can be freely inserted with the bioreactor plate into the assembly device 120. The stop pins 122 on the longitudinal side between the holders 111 ensure exact positioning. The pressing plate 113 is now pushed downward by means of the toggle lever 118 without jerking. The pressing plate 113 is guided with the guide columns 114. Three spacers 123 transmit the force onto the metering device so that the sterile filter vents are not damaged. In an advantageous variant, the spacers 123 can be configured as spring elements so as to achieve a defined pressing force.

When disassembling a metering device 54 according to the invention, the bioreactor plate 1 with the assembled multi-metering device 54 is slid on the base plate 110 into the holders 111 so that said plate is fixed in the radial direction by the holders 111. Due to the pivotable mounting of the hooks 112 on the pressing plate 113, the metering device can be freely inserted with the bioreactor plate into the mounting device 120. The stop pins 112 on the longitudinal side between the holders 111 ensure again exact positioning.

Subsequently, the hooks 112 are folded down by the user by means of the handles 119′ and engage below the metering device 54. By actuating the toggle lever 118, the pressing plate 113 is now pulled upward without jerking, thereby lifting the metering device 54 via the hooks 112 away from the bioreactor plate 1. Then, the latter can be pulled out of the downholders 11 again. The advantage of this assembly device according to the invention is, among other things, that the vertical tensile force required for detaching the metering device 54 from the bioreactor plate is transmitted uniformly so that the metering device 54 cannot tilt during disassembly. Cross-contamination of adjacent reaction vessels due to culture medium sloshing around thus can be avoided.

In order to avoid cross-contamination when pulling the bioreactor plate out of the assembly device 120, a drip plate (not illustrated) can be inserted beforehand in the guide slots 124 between the bioreactor and the metering device.

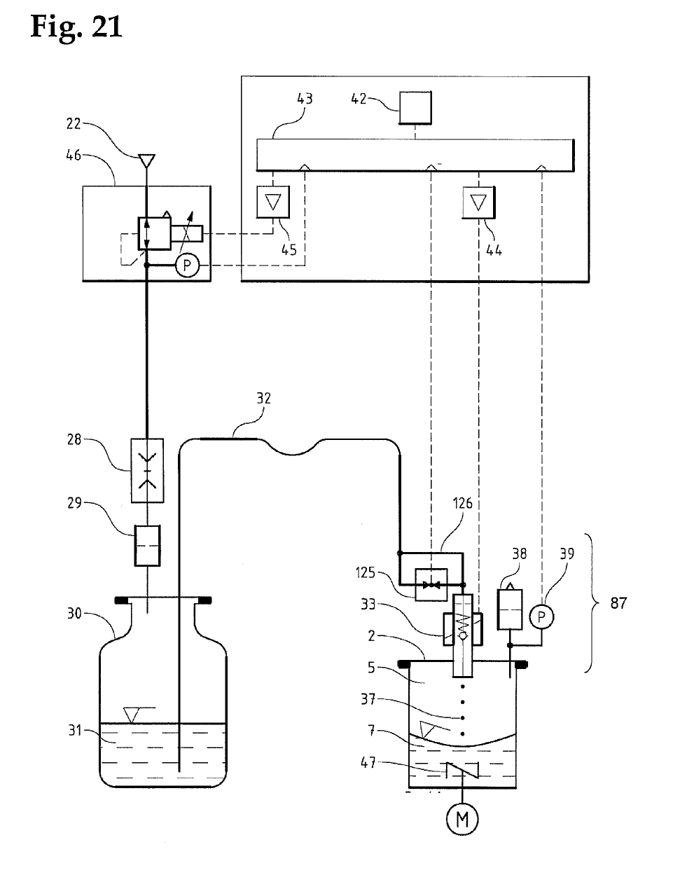

FIG. 21 shows another embodiment of the device according to the invention which is expanded by a pressure sensor 125 and a bypass 126. The pressure sensor 125 is arranged as close as possible to the drop generator 33. With the pressure sensor 125, the effective pressure in the fluid necessary for metering is measured directly at the inlet of the drop generator. Deviations from the necessary required differential pressure upstream of the drop generator 33 due to flow losses in the transfer line 32 and due to static pressure differences because of the different height position of reservoir 30 and bioreactor 2 thus can be measured. Controlling takes place through the process controller 43. The metering accuracy is measurably improved. The bypass 126 ensures that the volume flow in the pressure sensor 125 remains small and the pressure measurement is not influenced negatively. In the illustrated embodiment, the pressure sensor 125 is arranged above the drop generator 33. In a further embodiment (not shown in FIG. 21), the pressure sensor 125 is integrated in the drop generator 33. In another embodiment, a pressure sensor 125 is used without the bypass.

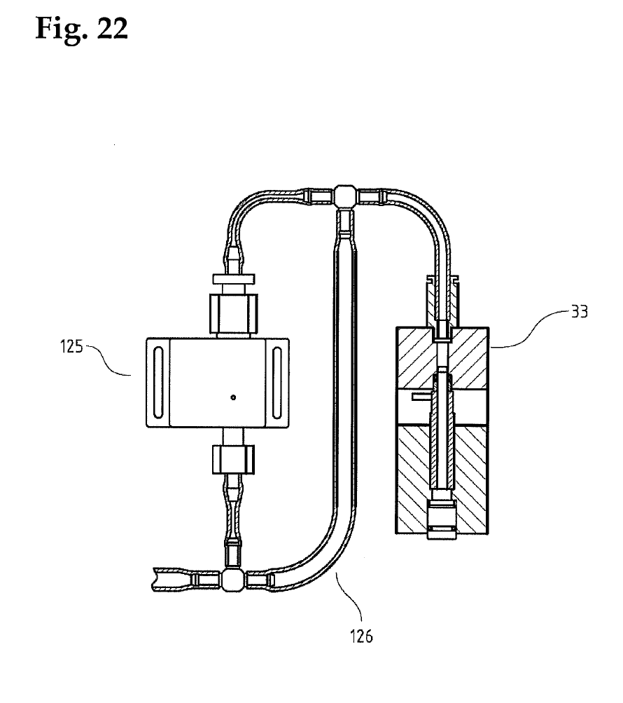

FIG. 22 shows a preferred arrangement of the pressure sensor 125 and the bypass 126 on the drop generator 33. Advantageously, the pressure sensor 125 is an inexpensive single use pressure sensor from the company PendoTECH based in Princeton, USA. This pressure sensor can be autoclaved for a few cycles. The flow cross-section of the bypass 126 is considerably larger than the flow cross-section in the pressure sensor 125. Due to the bypass circuit, fluid keeps flowing through the pressure sensor 125 so that no film can deposit in the pressure sensor 125. The pressure sensor 125 is positioned at the height of the inlet of the drop generator 33 so that a static pressure difference as small as possible occurs between pressure sensor 125 and drop generator 33.

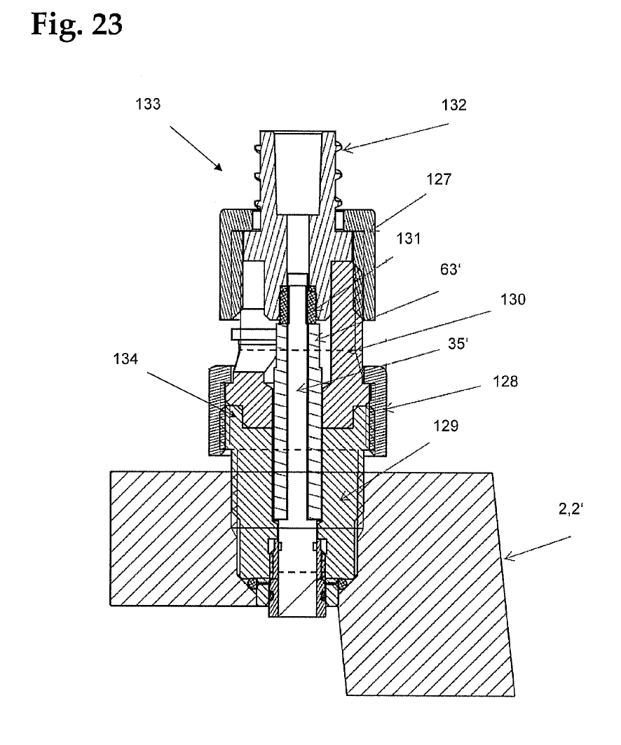

FIG. 23 shows an adaptor 133 for attaching onto the bioreactor 2. The adaptor 133 is a two-piece design and comprises a lower adaptor part 129 and an upper adaptor part 130. The two-piece design allows an improved alignment of the adaptor 133 during the assembly on the bioreactor 2. The upper and the lower adaptor part are aligned concentrically to each other by means of the centering seat 134 and positioned on the bioreactor plate 2. A lower screwcap 128 fixes the adaptor parts. A transfer line connector 132 is inserted concentrically into the upper adaptor part 130 and fixed with an upper screwcap 127. The transfer line connector 132 serves at the same time as seat for a silicone seal 131 which sealingly connects the transfer line connector 132 to the valve 35′. The coil is configured as a magnetic coil 63′.

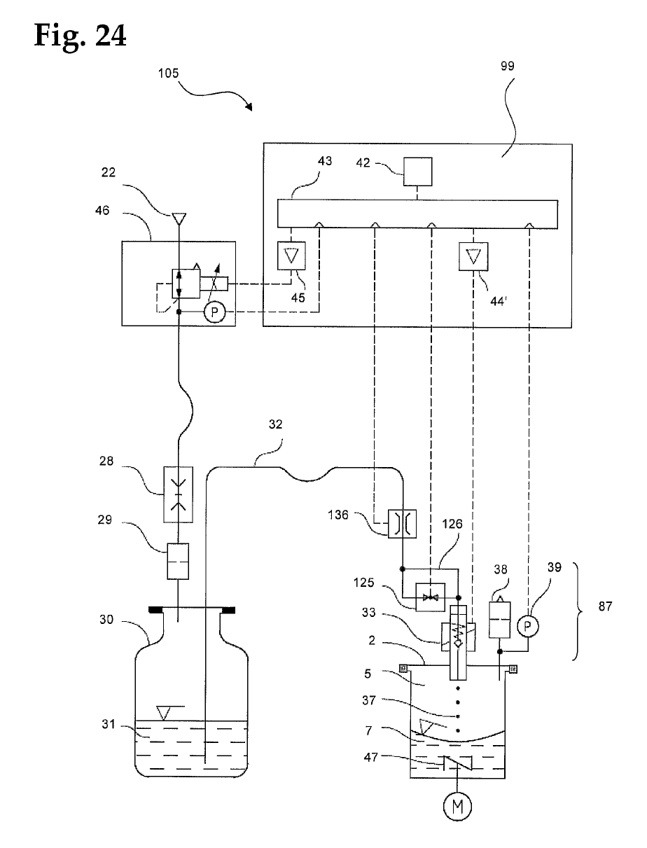

FIG. 24 shows another embodiment of the metering system illustrated in FIG. 7 and in FIG. 21, wherein the metering system is expanded by a flow sensor 136. The flow sensor 136 is a metering rate determination means arranged in the transfer line 32. The metering rate determination means determines the second metering rate when the fluid enters the drop generator 33.

The fluid is conveyed by means of overpressure in the reservoir through the transfer line 32 from the reservoir 30 to the feed line of the drop generator 33. The drop generator 33 meters the fluid 33 so as to form individual drops 37 with a defined volume of 100 nl to 100 μl. By controlling the frequency and the opening time of the electromagnetically actuatable valve by means of the control device 99 of the drop generator 33, a defined amount of the fluid 31 gets into the nozzle and leaves the same as an individual drop 37. The drop 37 crosses the headspace 5 and impinges on the culture medium 7. There, it subsequently mixes with the culture medium 7 which is kept in motion by means of the stirrer 47. By repeatedly opening the valve 35, the drop generator 33 can generate an exactly determined number of drops 37 and thus can obtain a determined first rate. For improving the accuracy of the metering system according to the invention, a second metering rate is measured by means of a flow sensor and recorded by the control device 99. If this value does not correspond to the first metering rate determined by the control device, the valve driver 44′ is activated by means of the process controller 43, and the control values, comprising, for example, frequency and opening period of the drop generator 33, are adjusted. In a further embodiment, a pressure sensor 125 can be dispensed with if the flow sensor 136 is used.

The pressure sensor 125 is arranged as close as possible to the drop generator 33. With the pressure sensor 125, the effective pressure in the fluid 31 necessary for metering is measured directly at the inlet of the drop generator. Deviations from the necessary required differential pressure upstream of the drop generator 33 due to flow losses in the transfer line 32 and due to static pressure differences because of the different height position of reservoir 30 and bioreactor 2 thus can be measured and regulated by the process controller 43. The metering accuracy is measurably improved. The bypass 126 ensures that the volume flow in the pressure sensor 125 remains small and the pressure measurement is not negatively influenced. In the illustrated embodiment, the pressure sensor 125 is arranged above the drop generator 33.

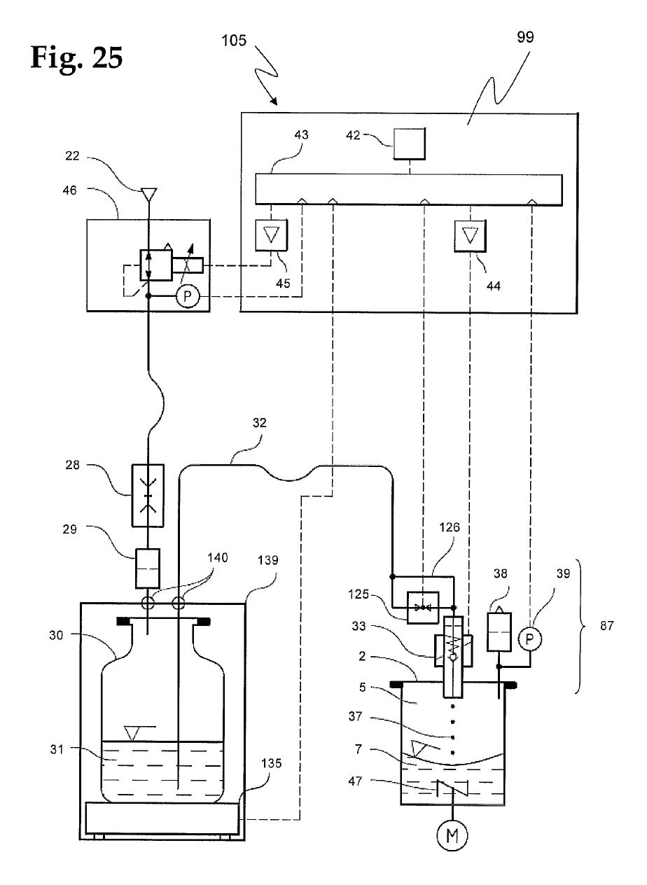

FIG. 25 shows the same metering system of system FIG. 24, with the difference that the second measured metering rate is determined by a weighing means 135. The weighing means 135 preferably involves a precision scale. The embodiment according to FIG. 25 shows at least one reservoir 30, positioned on the weighing means 135. In order to protect the weighing means 135 against disturbances, the at least one reservoir 30 and the weighing means 135 are surrounded by a housing 139. The housing 139 has openings, preferably with fixation means 140, which serve as connections for the pressure supply unit 46 and the transfer line 32. The weighing means 135 measures the weight of the fluid 31 in the reservoir 30 during the metered addition of the fluid into the reaction vessel 2. The second metering rate measured in this manner is compared with the first metering rate determined by the control device. In the event that there is a deviation, the control values, e.g., frequency and opening time of the drop generator 33, are adjusted by means of the control device 99. Besides the weighing means 135, the pressure sensor 125 and the bypass 126 also serve for improving the metering accuracy of the metering system according to the invention.

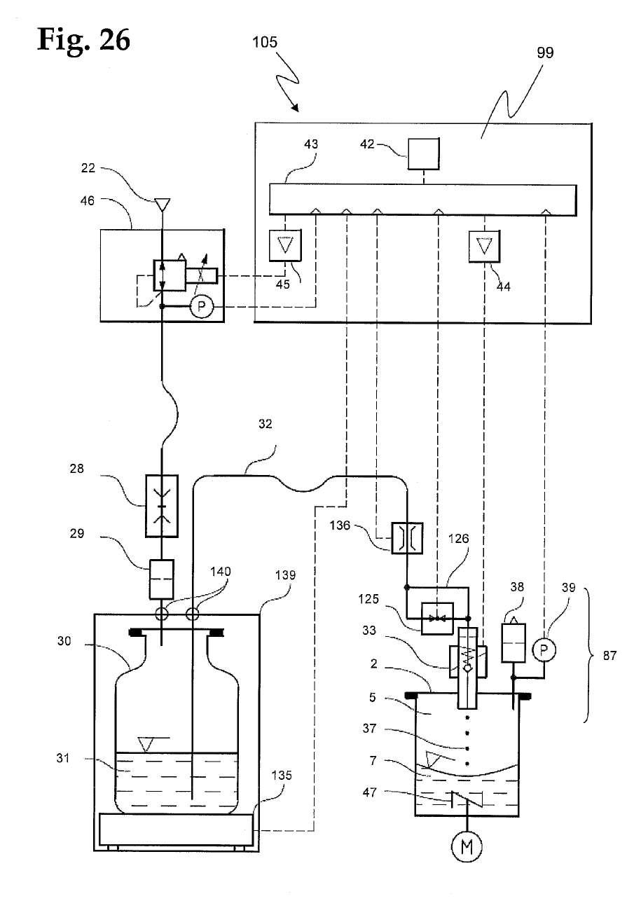

FIG. 26 shows the metering system of FIG. 24 and FIG. 25, wherein both metering rate determination means, the weighing means 135, and the flow sensor 136 are present, and the pressure sensor 125 is used with bypass 126.

### REFERENCE LIST

1 Multiwell bioreactor plate
2, 2′ Reaction vessel, bioreactor
3 Sterile seal
4 Sterile filter
5 Headspace
6 Liquid level, liquid surface
7 Culture medium
8 Heat conductor
9 Temperature sensor
10 pH-sensitive material
11 Optical sensor
12 CO₂ supply
13 O₂/air supply
14 NH₃ supply
15 Sealing element
16 Sterile semi-permeable membrane
17 DO-sensitive material
18 Optical DO sensor
19 Heat conductor
20 Heater
21 Gas bubbles
22 Compressed air source
23 Maintenance unit
24 Micro-filter
25 Electropneumatic pressure regulator
25a Pressure sensor
26 Shut-off valve
27 Manometer
28, 28a, 28b Quick coupling
29, 29′, 29a Sterile filter
30 Reservoir
31, 31′ Fluid
32, 32′ Transfer line
33, 33′ Drop generator
34 Particle filter
35 Valve, magnetic valve
36 Nozzle
37 Drop, added metered fluid volume
38 Sterile filter vent, venting device
39 Pressure sensor, device for measuring pressure
40 Sensors for T, pH, DO, X
41 Orbital shaker
42 Cultivation program
43 Process controller, process controlling unit
44, 44′ Valve driver
44a, 44b Valve driver
45 set value signal for pressure
46 Pressure supply unit, device for pressurization
47 Stirrer
48 Pressure chamber
49 Bag
49a Sampling line
49b Sterile coupling
50 Valve
51 Sampling valve
52 Sample container
53 Sample fluid, fluid
54 24-channel metering device, multi-metering device
55 Multi-distributor, distributor plate
56 Grid plate
57 Insert
57a O-ring
58 Inner edge
59 Gassing pipe
60 Vent hole
60a Vent hole
61 Pin
62 Bore
63, 63′ Coil, magnetic coil
64 Annular gap
65 Printed circuit board
66 Cable
67 Screw part
68 O-ring
69 Sealing ring
70 Thread
71 Stop
72 Thread
73 Coil holder
74 Snap-in connector
75 Tube connector
76 Clamping member
77 Fastening bore
78 Connecting wires
79 Thread
80 O-ring
81 Spring element
82 Downholder
83 Screwcap
84 Seal
85 Split biconical seal
86 Clamping ring
87, 87′ Metering device
89 Closure element
91 Feed line
35′ Valve ball
35″ Valve seat
96 Device for sampling
99 Control device
105 Metering system
110 Base plate
111 Downholder
112 Hook
113 Pressing plate
114 Guide column
115 Beam
116 Bolt
117 Lifting device
118 Toggle lever
119 Inner wall
119′ Handle
120 Assembly device
121 Inner wall
122 Stop pin
123 Spacer
124 Guide slot
125 Pressure sensor
126 Bypass
127 Upper screwcap
128 Lower screwcap
129 Lower adaptor part
130 Upper adaptor part
131 Silicone seal
132 Feed adaptor
133 Adaptor
134 Centering seat
135 Weighing means
136 Flow sensor
139 Housing
140 Fixation means
DR1, DR2 Metering rate
SW Control value
Q1, Q2 First flow cross-section, second flow cross-section

1. A metering system for metering at least one fluid at a determined first metering rate from at least one reservoir into one or a plurality of reaction vessels, comprising:
at least one metering device;
means for determining a first pressure downstream of the metering device;
means for determining a second pressure upstream of the metering device;
a device for pressurization, wherein said device is suitable for pressurizing the fluid in the reservoir at the second pressure;
a control device, wherein the control device is suitable for setting at least one control value for the metering device on the basis of a differential pressure between the second pressure and the first pressure and the determined first metering rate; and metering rate determination means, wherein said metering rate determination means are suitable for measuring a second metering rate, and the control device is suitable for readjusting the at least one control value on the basis of a difference between the first metering rate and the second metering rate.

2. The metering system according to claim 1, wherein the metering determination means preferably comprise weighing means, particularly preferred a precision scale.

3. The metering system according to claim 2, wherein the at least one weighing means is suitable for measuring the second measured metering rate by determining a mass difference of the fluid in the reservoir within a certain measuring interval.

4. The metering system according to claim 1, wherein the metering rate determination means comprises a flow sensor, wherein the flow sensor is arranged in a transfer line between the at least one reservoir and the metering device and is suitable for determining the second measured metering rate.

5. The metering system according to claim 4, wherein the flow sensor is a single use flow sensor.

6. The metering system according to claim 1, wherein the means for determining a second pressure comprises a pressure sensor.

7. The metering system according to claim 6, wherein the pressure sensor is integrated in the metering device.

8. The metering system according to claim 6, wherein the pressure sensor comprises a bypass.

9. The metering system according to claim 8, wherein the pressure sensor has a first flow cross-section and the bypass has a second flow cross-section, wherein the flow cross-section of the bypass is larger than the flow cross-section of the pressure sensor.

10. The metering system according to claim 1, wherein a device for taking samples from the reaction vessel is provided.

11. A method for metering a fluid at a determined first metering rate from a reservoir into a reaction vessel with a metering device which is suitable for generating individual drops of the fluid, comprising the steps of:
detecting upstream of the metering device a second pressure;
detecting downstream of the metering device a first pressure;
forming a differential pressure from the difference between the second pressure and the first pressure;
determining at least one control value for the metering device from the differential pressure and the determined first metering rate,
wherein the at least one control value comprises the opening period and/or the frequency of the metering device, and a second metering rate (DR2) is measured by metering rate determination means (135, 136); and based on a difference between the first determined metering rate and the second measured metering rate, the at least one control value (SW) is readjusted.

12. The method according to claim 11, wherein a control device controls the opening period and/or the frequency of the metering device in such a manner that the second measured metering rate corresponds to the first determined metering rate.

13. The method according to claim 11, wherein the metering rate determination means comprise at least one weighing means, wherein the at least one weighing means is arranged below or above one or a plurality of reservoirs and determines a weight value of the fluid in the reservoir, wherein the change of the weight value within a certain measuring interval corresponds to the second measured metering rate.

14. The method according to claim 11, wherein the metering rate determination means comprise at least one flow sensor, wherein the flow sensor determines the second measured metering rate.

15. The method according to claim 11, employing a metering system for metering at least one fluid at a determined first metering rate from at least one reservoir into one or a plurality of reaction vessels, comprising:
at least one metering device;
means for determining a first pressure downstream of the metering device;
means for determining a second pressure upstream of the metering device;
a device for pressurization, wherein said device is suitable for pressurizing the fluid in the reservoir at the second pressure;
a control device, wherein the control device is suitable for setting at least one control value for the metering device on the basis of a differential pressure between the second pressure and the first pressure and the determined first metering rate; and
metering rate determination means, wherein said metering rate determination means are suitable for measuring a second metering rate, and the control device is suitable for readjusting the at least one control value on the basis of a difference between the first metering rate and the second metering rate.
